(19) United States
(12) Patent Application Publication
(10) Pub. No.: US 2003/0219364 A1
(43) Pub. Date: Nov. 27, 2003

(54) Apparatus for converting a hydrocarbon-containing flow of matter

(76) Inventors: Gesine Arends, Gerlingen (DE); Peter Riegger, Stuttgart (DE)

Correspondence Address: STRIKER, STRIKER & STENBY, 103 East Neck Road, Huntington, NY, 11743, US

(21) Appl. No.: 10/396,144

(22) Filed: Mar. 25, 2003

(30) Foreign Application Priority Data
Mar. 28, 2002 (DE) 102 13 891.5

(51) Int. Cl. B01J 8/04

(52) U.S. Cl. 422/198; 422/190

(57) ABSTRACT

An apparatus (10) for converting a hydrocarbon-containing flow of matter (4) to a hydrogen-enriched fluid flow (10) includes a heating apparatus (5) for production of a heating current (6), whereby the flow of matter (4) is converted to the hydrogen-enriched fluid flow (10) in a first converter (2) as well as in a second converter (3) arranged behind the first converter in a flow direction. A heating element (8) that is flowed-through by the heating current (6) is provided for heating at least one of the two converters (2, 3). The invention provides an improved system efficiency, in that a disadvantageous cooling of the second converter (2) is effectively avoided. This is achieved according to the present invention in that at least in one operating phase, the heating current (6) flows to the second converter (3) completely in a counterflow to the flow of matter (4).

### BACKGROUND OF THE INVENTION

The present invention relates to an apparatus for converting a hydrocarbon-containing flow of material into a hydrogen-enriched fluid flow with a heating device for production of a heating current.

Combustion cells are electrochemical transformers of chemical energy into electrical energy. In many cases, one's goal is to convert hydrogen-rich fuel for the combustion cell unit from hydrocarbonous material, such as natural gas, gasoline, diesel, methanol or the like. In this connection, a corresponding apparatus for converting the hydrocarbon to a hydrogen-rich substance is necessary.

For example, the conversion takes place by means of reforming, or steam reformation. The steam reformation of hydrocarbons is generally endothermic. The supply of the heat of reaction takes place in the common manner through a burner. A heating current produced hereby, that is, hot flue gas, can be used for heating of the matter flow in a first stage or converter, whereby, likewise, already in this stage, the matter flow is at least partially converted.

In addition, in particular, the heating current, or flue gas, of the burner as well as the heat radiation coming from the burner can be used for heating of a second, hotter stage or reactor stage of the reformer.

With the two-stage steam reformers known up to this point, according to the disclosure of B. Vogel et al: “Hydrogen Generation Technologies for PEM Fuel Cells”, Tagungsband Fuel Cell Seminar, Palm Springs, Nov. 1998, the flue gas of a burner is already used for educt preheating as well as for heating of the reactor stages. In this manner, the reformer is additionally seen as a heat exchanger for heating use of residual flue gas.

It is disadvantageous with corresponding steam reformers, however, that the flue gas flow to the side of the reaction zone facing away from the burner, or the second stage, is in a direct current to the educt current, so that among other things, the flue gas cooled by educt preheating can be brought into heating contact with hot reactor zones. In this manner, an undesired, disadvantageous heat transmission from the reactor stage into the flue gas can take place, so that the reforming of the matter flow in this reaction stage is affected disadvantageously.

### SUMMARY OF THE INVENTION

One object of the present invention, in contrast, is to provide an apparatus for converting a hydrocarbon-containing matter flow or current to a hydrogen-enriched fluid flow or current with a heating device for production of a heating current, whereby the matter flow is converted in a first converter, as well as in a second converter arranged behind the first converter in the flow direction, and a first heating element that is able to be flowed through by the heating current is provided for warming the two converters, which in contrast to the state of the art, has an improved system efficiency, whereby a disadvantageous cooling of the second converter is effectively prevented.

This object is resolved with a device of the above-described type, in accordance with the present invention.

Accordingly, the inventive apparatus illustrates that at least in one operating phase, the heating current flows to the second converter completely in a counterflow to the matter flow.

With the assistance of these features, the transmission of heat from a relatively hot heating current onto or into a second converter unit is markedly improved. At the same time, a cooling of a similarly hot region of the second converter is effectively prevented, so that, in particular, the system efficiency of the device can be separately improved.

In an advantageous variation of the invention, the heating current flows in at least one operating phase to the first and second converters completely in a counterflow to the flow of matter. In this. manner, the heat transmission of a relatively hot heating current to the likewise somewhat colder matter flow, or educt matter flow, is also improved. Thereby, the broadest use of the heat energy of the heating current for heating the matter flow takes place.

In a particularly further embodiment of the invention, at least one second heating element that is able to be flowed-through by the heating current is provided for heating one of the two converters in a start phase. With the assistance of these characteristics, an advantageous, particularly fast heating of at least one of the two converters, in particular, the second converter or reactor stage, in a start or cold start phase is possible. For example, the first heating element is arranged on a side of one of the two converters and the second heating element on a side of one of the two converters that is opposite to this first side. In this manner, an increase of the heat-transmitting surface, and therewith, an improvement of the heat transmission from the heating current to the matter flow, are possible.

Essentially, for improving the heat transmission, a further increase of the heating-transmitting surfaces is possible by means of a corresponding profiling or the like. Likewise, it is particularly advantageous to use heat-transmitting materials.

Preferably, the second heating element is arranged between the two converters. In this manner, a particularly fast heating of the two converters in the start phase without great expenditure is able to be realized.

Advantageously, an inlet opening and/or outlet opening of the first and/or second heating element has at least one apportioning element for apportioning of the heating current. With the help of a corresponding apportioning element, in particular, as a function of the respective operating state, that is, for example, in the “normal” operating phase and/or in the start phase, an advantageous apportioning of the heating current, or its volume, and therewith, an apportioning of the heating-transmitting heating energy can take place. Possibly, the apportioning element is formed as a flap, valve, or the like.

Preferably, at least one control unit for controlling the apportioning element is provided. Likewise, for example, by actuation of the apportioning element, in particularly, by a complete opening or closing of the inlet and/or outlet opening, the through-flow of at least one or both heating elements can be effectively decreased or prevented. Possibly, the heating transmission can be substantially omitted by means of the corresponding heating element.

Preferably, the heating element is formed at least in the operating phase as an isolation element. For example, an advantageous thermal separation of the two converters is realized by closing of the inlet and/or outlet opening of the second heating element, which is preferably located between the two converters. In this manner, during the operating phase, a relevant heating transmission from the second converter or particularly hot reactor zones to the somewhat colder first converter or preheating state and/or in the likewise somewhat cooled heating current can be substantially prevented.

Generally, one or both converters can have a catalytically active material for advantageously converting the matter flow. Possibly, both converters have different catalytically active materials.

In one advantageous embodiment of the invention, both converters and/or both heating elements are arranged approximately coaxial to one another. In this manner, a similarly compact structure is realizable.

Preferably, the heating apparatus is arranged approximately coaxial to the converters and/or heating elements. With the aid of these features, an advantageous use of the heat energy of the heating apparatus is convertible.

Advantageously, the heating apparatus is arranged in the region of the relatively hot, second converter. In this manner, the second converter takes up the heat energy from the heating apparatus by means of a heating line as well as heat radiation.

In an advantageous variation of the invention, the heating apparatus is arranged approximately central to the converters and/or heating elements. In this manner, a particularly compact structure and therewith, a relatively minimal heating loss according to the invention is realizable. In addition, a particularly uniform temperature separation over the cross section of the apparatus according to the invention is realizable.

Preferably, the inventive apparatus has a cylindrical structure with an outward associated heating apparatus or with an inward associated heating apparatus.

In an advantageous manner, an apparatus according to the invention, in particular, a steam reformer, is provided in a fuel cell assembly for energetic utilization of the hydrogen-enriched fluid flow. Likewise, one or more treatment units for treatment of the fluid flow are provided between the apparatus of the present invention and the fuel cell assembly. Corresponding fuel cell assemblies are used, for example, in motor vehicles, fuel-heating coupling assemblies, or the like.

### BRIEF DESCRIPTION OF THE DRAWING

FIG. 1 is a schematic illustration of a cross section through a cylindrical reformer according to the present invention.

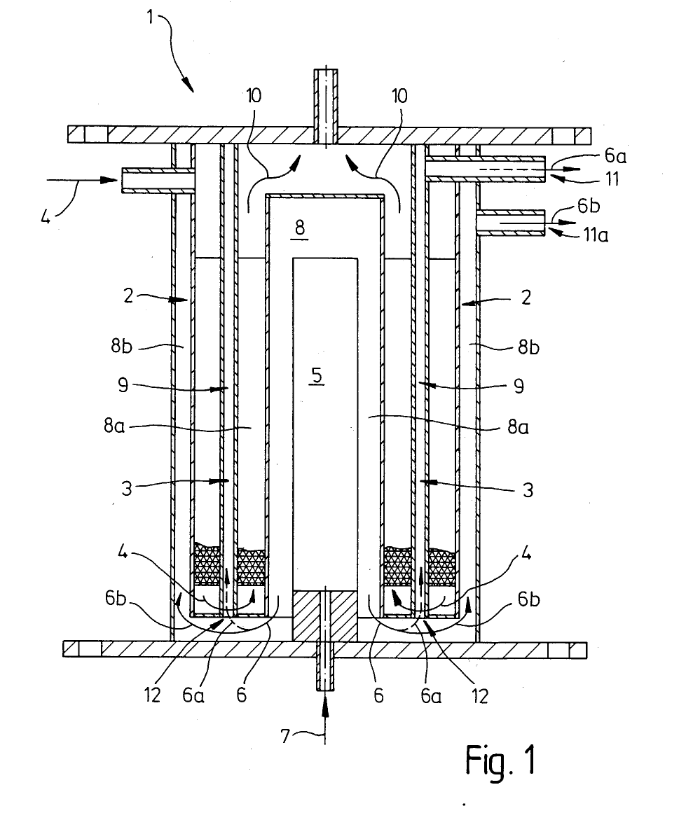

### DETAILED DESCRIPTION OF THE PREFERRED EMBODIMENTS

One embodiment of the present invention is illustrated in the drawing and will next be described in greater detail with reference to this figure.

A two-stage steam reformer 1 has a first reforming state 2 and a second reforming stage 3, or reactor 3. For heating the steam reformer 1, a burner 5 is provided, which is disposed approximately centrally in a cylindrical steam reformer 1. For example, in the burner 5, natural gas 7 or the like is likewise catalytically combusted. Flue gas, or burner exhaust 6, is used for heating the two reforming stages 2 or 3.

According to the invention, the flue gas 6 flows through a flue gas chamber 8 in a “normal” operation situation. The flue gas chamber 8 includes the flue gas chamber 8a in the region of the burner 5 and the flue gas chamber 8b in a region facing away from the burner 5, or the second reactor stage 3.

In a first stage, an educt flow is preheated. This can likewise contain catalytically active material, so that, likewise, first pre-reactions for conversion of the educt 4 can take place.

In a region of the flue gas chamber 8b, the heat transmission from the flue gas 6 onto the educt material flow 4 take place substantially by means of a heating line. According to the invention, a complete counterflow guiding of the flue gas flow 6 to the educt material flow 4 is hereby realized.

The heat energy of the burner 5 is transmitted on the second, hotter reforming stage 3 in the region of the flue gas chamber 8a by means of heat radiation as well as a heating line to the educt material flow 4, so that, in this manner, in particular, the endothermic steam reforming of the hydrocarbon-containing educt matter flow 4 takes place exclusively eventually in the intermediate product produced in the first stage 2. Generally, the second reforming stage 3 includes catalytically active material (not shown).

In a start phase or cold start phase, the flue gas flow 6 can be lead into a column 9. The flue gas flow 6 hereby can be separated, for example, into a flue gas partial flow 6a and a flue gas partial flow 6b. During this particular operating state, at least the second converter 3, or the second reactor stage 3, is operated at least partially in direct current, that is, the flue gas partial flow 6a and the educt flow 5 flow in the same direction.

At the same time, the first reactor stage 2, by means of the flue gas partial flow 6a as well as the flue gas partial flow 6b, is operated in counterflow with reference to the educt flow 4. According to the invention, the heating-transmitting surfaces are separately enlarged through the column 9, so that, in this manner, a particularly fast heating of the reformer 1 can take place in the cold start phase. Accordingly, in an advantageous manner, the heating time of the reformer 1 is shortened substantially.

In the “normal” operating phase, the reformer 1 is operated, such that in the region of an outlet opening 11, through which the flue gas partial flow 6a flows out of the reformer 1, a flap (not shown) for closing the outlet opening 11 is provided. The corresponding flap is controlled, for example, by means of a control unit. In particular, this can detect an operating temperature of the reformer 1 by means of temperature sensors. Alternatively, also the non-illustrated flap can be closed in the region of the outlet opening 11 after a time period provided by the control unit.

In the “normal” operating phase, the flue gas 6a in the column 9 forms a thermal isolation layer between the reactor stages 2 and 3. In this manner, a thermal separation of the relatively hot chamber 3 from the somewhat colder chamber 2 of the reformer 1 is realized in an advantageous manner.

Alternatively, or in combination hereto, a flap, a valve, or the like can be disposed in a region of an inlet opening 12 of the column 9. In this manner, a formation of a thermal isolation layer 9 during the “normal” operating phase is likewise realizable with a closed flap in the region of the inlet opening 12.

The reformat 10 flowing out of the reformer 1 can be supplied, for example, in a non-illustrated manner to a fuel cell assembly for production of electrical energy.

Preferably, the steam reforming takes place with temperatures of approximately 800° C., whereby the burner 5 produces temperatures of approximately 1000° C. and 1200° C., so that a detrimental NOₓ-formation is substantially prevented.

It will be understood that each of the elements described above, or two or more together, may also find a useful application in other types of constructions differing from the types described above.

While the invention has been illustrated and described herein as an apparatus for converting a hydrocarbon-containing flow of matter, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. Apparatus (1) for converting a flow of matter (4) containing hydrocarbons to a hydrogen-enriched fluid flow (10) with a heating apparatus (5) for production of a heating current (6), whereby the flow of matter (4) is converted in a first converter (2) as well as in a second converter (3) arranged behind said first converter in a flow direction to a hydrogen-rich fluid flow (10) and a first heating element (8) that is flowed-through by a heating current is provided for heating at least one of the first and second converters (2, 3), characterized in that at least in one operating phase, the heating current (6) flows to the second converter (3) completely in a counterflow to the flow of matter (4).

2. Apparatus (1) according to claim 1, characterized in that at least in one operating phase, the heating current (6) flows to the first and second converters (2, 3) completely in counterflow to the flow of matter (4).

3. Apparatus (1) according to claim 1, characterized in that at least one second heating element (9) that is flowed-through by the heating current (6) is provided for heating one of the first and second converters (2, 3) in a start phase.

4. Apparatus (1) according to claim 3, characterized in that the at least one second heating element (9) is disposed between the first and second converters (2, 3).

5. Apparatus (1) according to claim 3, characterized in that an inlet opening (12) and/or an outlet opening (11) of the first and/or second heating element (6, 8) has at least one apportioning element for apportioning the heating current (6).

6. Apparatus (1) according to claim 5, characterized in that at least one control unit is provided for controlling the apportioning element.

7. Apparatus (1) according to claim 3, characterized in that the first and second converters (2, 3) and/or the first and second heating elements (8, 9) are arranged approximately coaxial to one another.

8. Apparatus (1) according to claim 3, characterized in that the heating apparatus (5) is arranged approximately coaxial to the converters (2, 3) and/or the heating elements (8, 9).

9. Apparatus (1) according to claim 3, characterized in that the heating apparatus (5) is arranged approximately centrally to the converters (2, 3) and/or the heating elements (8, 9).

10. Fuel cell assembly with a fuel cell unit and an apparatus (1) for converting a hydrocarbon-containing flow of matter (4) to a hydrogen-enriched fluid flow (10), whereby the flow of matter (4) is converted in a first converter (2), as well as in a second converter (3) arranged behind the first converter (2) in a flow direction, to a hydrogen-enriched fluid flow (10), and a heating apparatus (5) is provided for production of a heating current (6) as well as a first, heating element (8) that is flowed-through by the heating current (6) for heating at least one of the first and second converters (2, 3), characterized in that the apparatus (1) is formed according to claim 1.

11. Motor vehicle with a fuel cell assembly, characterized in that the fuel cell assembly is formed according to claim 10.
